(19) United States
(12) Patent Application Publication
(10) Pub. No.: US 2008/0002156 A1
(43) Pub. Date: Jan. 3, 2008

(54) OPTICAL PROJECTOR

(75) Inventor: Tzu-Huan Hsu, Taipei County (TW)

Correspondence Address: THOMAS, KAYDEN, HORSTEMEYER & RISLEY, LLP, 600 GALLERIA PARKWAY, STE 1500, ATLANTA, GA, 30339, US

(73) Assignee: BENQ CORPORATION, Taoyuan Shien (TW)

(21) Appl. No.: 11/754,415

(22) Filed: May 29, 2007

(30) Foreign Application Priority Data
Jul. 3, 2006 (TW) 95124206

(51) Int. Cl. G03B 21/16

(52) U.S. Cl. 353/57; 353/52

(57) ABSTRACT

An optical projector comprising a main body and a sensing module is provided. The main body comprises a controlling unit, a heat-dissipating unit, a projection lens for projecting an image and at least a vent. The sensing module is disposed in the main body. The sensing module and the heat-dissipating unit respectively are electrically connected to the controlling unit. The hot air inside the main body exchanges with the cool air outside the main body through the vent. When the sensing module detects an external object approaching the vent, such as entering a predetermined range around the vent, the sensing module sends a signal to the controlling unit for activating an anti-overheating mechanism; for example, actuating the heat-dispersing unit or/and displaying a warning image on a screen.

### This application claims the benefit of Taiwan application Serial No. 95124206, filed Jul. 3, 2006, the subject matter of which is incorporated herein by reference.

### BACKGROUND OF THE INVENTION

1. Field of the Invention

The invention relates in general to an optical projector, and more particularly to an optical projector having a sensing module for detecting whether the air inlet or the air outlet of the optical projector is blocked by an external object and for activating an anti-overheating mechanism if the air outlet or the air inlet is blocked, which may severely affect dissipation efficiency.

2. Description of the Related Art

For commercial or entertainment use, the main function of a projector is to enlarge an image then to project the enlarged image onto a screen. Conventional projector mainly comprises a projection lens, an optical engine and a lamp. The light produced by the lamp passes through the optical engine, and then the enlarged image is projected onto a screen through the projection lens. When a projector is in use, the lamp emits the light continuously and the intensity of the light must be strong enough to project the enlarged image onto a screen. However, the heat is increased as the lamp continueously produces the light. Meanwhile, when the light emitted by the lamp is projected to the optical engine, the optical engine is heated and the temperature inside the projector would get higher. If the projector is over-heated, the internal elements of the projector are susceptible to be damaged. Therefore, the dissipation design of heat is crucial to a projector.

Normally, a heat-dissipating device is installed in conventional projector for dissipating the heat. The heat-dissipating device is normally embodied by a fan for dissipating the heat, and an air inlet and an air outlet are normally included on the housing of the projector. With the operation of the fan, the air with normal temperature is guided into the projector via the air inlet to cool down the elements inside the projector, and then the hot air inside the projector is dissipated via the air outlet. Thus, the hot air is efficiently dissipated, and the projector would not operate in an over-heated status. Because the lamp is the main source of the heat, the fan and the air outlet are mainly located near the lamp, and the air inlet is located near other elements of the projector. However, in the course of operating the projector, some external objects may accidentally block the air outlet or the air inlet, making the fan unable to effectively guide cool air into the projector or dissipate the over-heated air from the projector. Consequently, the projector would be over-heated.

### SUMMARY OF THE INVENTION

The invention is directed to an optical projector having a sensing module for sensing whether the air outlet or the air inlet of the optical projector is blocked by an external object and for activating an anti-overheating mechanism to enhance the dissipation effect or remind the user of removing the external object blocking the air outlet or the air inlet so that the heat-dissipating mode can function normally.

According to a first aspect of the present invention, an optical projector comprising a main body and a sensing module is provided. The main body comprises a controlling unit, a heat-dissipating unit, a projection lens for projecting an image and at least a vent. The sensing module is disposed in the main body. The sensing module and the heat-dissipating unit are electrically connected to the controlling unit respectively. The hot air inside the main body exchanges with the cool air outside the main body through the vent. When the sensing module detects an external object approaching the vent, such as entering a predetermined range around the vent, the sensing module sends a signal to the controlling unit for activating an anti-overheating mechanism.

According to a second aspect of the present invention, an optical projector comprising a main body and a sensing module is provided. The main body comprises a controlling unit, a heat-dissipating unit and a projection lens. The sensing module disposed in the main body neighbors the heat-dissipating unit and is capable of detecting within a sensing range. The heat-dissipating unit and the sensing module respectively are electrically connected to the controlling unit. The projection lens is for projecting an image. When the sensing module detects a change within the sensing range, the sensing module sends a first signal to the controlling unit, and the controlling unit sends a second signal to the heat-dissipating unit to enhance dissipation effect.

The invention will become apparent from the following detailed description of the preferred but non-limiting embodiments. The following description is made with reference to the accompanying drawings.

### BRIEF DESCRIPTION OF THE DRAWINGS

FIG. 1 is a perspective of an optical projector according to a preferred embodiment of the invention;

FIG. 2 is a block diagram showing the relationships between the elements of the optical projector of FIG. 1.

### DETAILED DESCRIPTION OF THE INVENTION

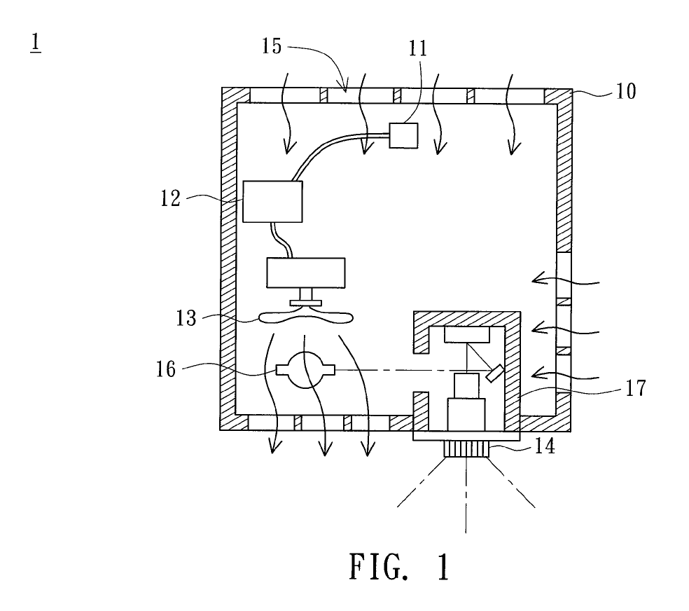

Refer to FIG. 1, a perspective of an optical projector according to a preferred embodiment of the invention. As indicated in FIG. 1, the optical projector 1 comprises a main body 10 and a sensing module 11. The main body 10 comprises a controlling unit 12, a heat-dissipating unit 13, a projection lens 14 and at least a vent 15. The vent 15 is an air inlet or an air outlet for example. However, the main body 10 may have both an air inlet and an air outlet, but in the present embodiment of the invention only one vent 15 is illustrated.

The heat-dissipating unit 13 is electrically connected to the controlling unit 12. The projection lens 14 is for projecting an image. The hot air inside the main body 10 exchanges with the cool air outside the main body 10 through the vent 15. The sensing module 11 disposed in the main body 10 is electrically connected to the controlling unit 12. When the sensing module 11 detects an external object approaching the vent 15, such as entering a predetermined range around the vent 15, the sensing module 11 sends a signal to the controlling unit 12 for activating an anti-overheating mechanism.

As indicated in FIG. 1, the optical projector further comprises a lamp 16 and an optical engine 17. The lamp 16 and the optical engine 17 are respectively disposed in the main body 10 and electrically connected to the controlling unit 12. The lamp 16 is for generating a light and sending the light to the optical engine 17 that enlarges and projects an image through the projection lens 14. The lamp 16 for producing the light is one of the main sources that generate heat inside the main body 10.

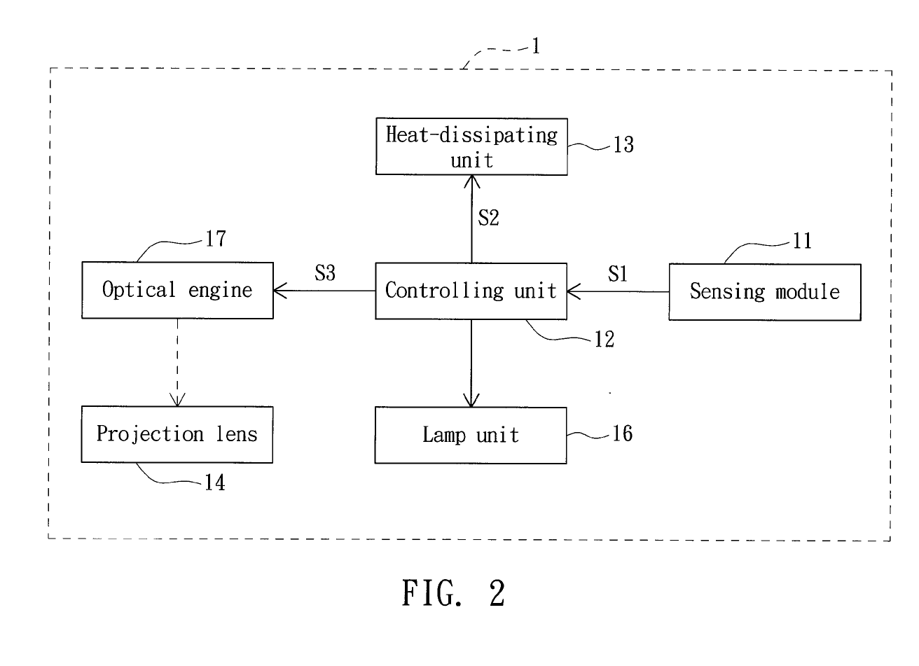

Refer to FIG. 2, a block diagram showing the relationships between the elements of the optical projector of FIG. 1. As indicated in FIG. 2, the controlling unit 12 is electrically connected to the sensing module 11, the heat-dissipating unit 13, the lamp 16 and the optical engine 17 respectively. The sensing module 11 is for detecting whether an external object enters a predetermined range around the vent 15 or not. The heat-dissipating unit 13 is for dissipating the hot air inside the optical projector for keeping the heat of the main body 10 under a safety level to prevent other elements inside the main body 10 from being overheated and damaged. The lamp 16 is a light source for generating light. After the light is projected onto the optical engine 17, an image is projected onto a screen through the projection lens 14.

After the optical projector 1 is activated, the lamp 16 electrically connected to the controlling unit 12 starts to provide the light to the optical projector 1. As the lamp 16 keeps generating heat inside the main body 10, the main body 10 is gradually heated up. When the optical projector 1 is in use, if an external object, such as a book, a file folder or a notebook computer, is placed too close to the vent 15, such as within a predetermined range around the vent 15, the external object will block the vent 15 partly or completely. Consequently, the hot air inside the main body 10 will be unable to exchange with the cool air outside the main body 10. Meanwhile, the sensing module 11 sends a signal to the controlling unit 12 for activating an anti-overheating mechanism.

In the present embodiment of the invention, the disposition of the sensing module 11 in the main body 10 is preferably around the vent 15 as illustrated FIG. 1. The vent 15 is an air inlet allowing the cool air outside the main body 10 to enter the main body 10 or an air outlet allowing the hot air inside the main body 10 to be dissipated from the main body 10. When the sensing module 11 detects the status in the air inlet or the air outlet is changed, an anti-overheating mechanism is activated at the same time. Meanwhile, the heat-dissipating unit 13 can be disposed around the lamp 16 or preferably disposed around the vent 15, so that the circulation between the hot air and the cool air is optimized and the heat inside the main body 10 is kept under a safety level.

When the controlling unit 12 activates the anti-overheating mechanism, the controlling unit 12 sends a warning image, which is projected onto a screen through the projection lens 14, to remind the user to remove the external object around the vent 15. Examples of the warning image include a text message describing the situation that an external object exists around the air outlet or the air inlet.

Besides, the anti-overheating mechanism can also be a dissipation enhancing mechanism. After the sensing module 11 sends a signal to the controlling unit 12, the controlling unit 12 drives the heat-dissipating unit 13 to enhance dissipation effect. The heat-dissipating unit 13 can be a fan for example. After the dissipation enhancing mechanism is activated, the controlling unit 12 drives the fan to increase the rotation speed, such that the circulation between the hot air and the cool air is boosted. However, when the anti-overheating mechanism is activated by the controlling unit 12, the warning image can be projected onto a screen and the heat-dissipating unit 13 can be driven to enhance dissipation effect at the same time.

In other words, the sensing module 11 can detect within a sensing range. When the sensing module 11 detects status changes within the sensing range, the sensing module 11 sends a first signal S1 to the controlling unit 12. After the controlling unit 12 receives the first signal S1, the controlling unit 12 further sends a second signal S2 to the heat-dissipating unit 13 to enhance dissipation effect. Or, the controlling unit 12 sends a third signal S3 to the optical engine 17 for sending a warning image through the projection lens 14 to remind the users. Or, when the controlling unit 12 sends the second signal S2 to the heat-dissipating unit 13 to enhance the dissipation enhancing mechanism, the controlling unit 12 also sends the third signal S3 to the optical engine 17 to send a warning image through the projection lens 14.

In practical application, the sensing module 11 is an infrared sensor for example. When the external object enters a predetermined range around the vent 15 and blocks the infrared light emitted by the infrared sensor, and the sensing module 11 then sends a signal to the controlling unit 12 for activating an anti-overheating mechanism. However, anyone who is skilled in the technology of the invention will understand that the technology of the invention is not limited thereto, and the sensing module 11 can be any element with detecting function.

A sensing module disposed in the optical projector disclosed in the above embodiment of the invention prevents the optical projector from being over-heated by detecting the status of the vent of the optical projector. When the sensing module is within a predetermined range around the vent (such as an air inlet or an air outlet for example) or when the sensing module detects a change within the sensing range, a signal is immediately sent to the controlling unit for activating an anti-overheating mechanism. Therefore, the optical projector is prevented from getting the over-heating problem that occurs due to the blockage of the vent.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An optical projector, comprising:
a main body comprising a controlling unit, a heat-dissipating unit, a projection lens and at least a vent, wherein the heat-dissipating unit is electrically connected to the controlling unit, the projection lens is for projecting an image, and the hot air inside the main body exchanges with the hot air outside the main body through the vent; and
a sensing module disposed in the main body and electrically connected to the controlling unit;
when the sensing module detects an external object entering a predetermined range around the vent, the sensing module sends a signal to the controlling unit for activating an anti-overheating mechanism.

2. The optical projector according to claim 1, wherein the anti-overheating mechanism is a warning image projected onto a screen through the projection lens.

3. The optical projector according to claim 1, wherein the anti-overheating mechanism is a dissipation enhancing mechanism and the controlling unit drives the heat-dissipating unit to enhance dissipation effect when the sensing module sends the signal to the controlling unit.

4. The optical projector according to claim 1, wherein the sensing module sends the signal to the controlling unit, then the controlling unit projects a warning image onto a screen through the projection lens and drives the heat-dissipating unit to enhance dissipation effect.

5. The optical projector according to claim 1, wherein the sensing module is disposed around the vent.

6. The optical projector according to claim 1, wherein the heat-dissipating unit is disposed around the vent.

7. The optical projector according to claim 1, wherein the vent is an air inlet through which cool air outside the main body enters the main body.

8. The optical projector according to claim 1, wherein the vent is an air outlet through which hot air inside the main body is dissipated from the main body.

9. The optical projector according to claim 1, wherein the sensing module is an infrared sensor.

10. The optical projector according to claim 1, wherein the heat-dissipating unit is a fan.

11. An optical projector, comprising:
a main body comprising a controlling unit, a heat-dissipating unit and a projection lens, wherein the heat-dissipating unit is electrically connected to the controlling unit, and the projection lens is for projecting an image; and
a sensing module disposed in the main body and neighboring the heat-dissipating unit, wherein the sensing module is capable of detecting within a sensing range, and the sensing module is electrically connected to the controlling unit;
wherein, when the sensing module detects a change within the sensing range, the sensing module sends a first signal to the controlling unit, and the controlling unit sends a second signal to the heat-dissipating unit to enhance dissipation effect.

12. The optical projector according to claim 11, wherein the controlling unit further sends a warning image projected onto a screen through the projection lens.

13. The optical projector according to claim 11, wherein the main body further comprises an air inlet through which cool air outside the main body enters the main body, and the sensing module neighbors the air inlet.

14. The optical projector according to claim 11, wherein the main body further comprises an air outlet through which hot air inside the main body is dissipated from the main body, and the sensing module neighbors the air outlet.

15. The optical projector according to claim 11, wherein the sensing module is an infrared sensor.

16. The optical projector according to claim 11, wherein the heat-dissipating unit is a fan.
